(19) United States
(12) Patent Application Publication
(10) Pub. No.: US 2007/0055413 A1
(43) Pub. Date: Mar. 8, 2007

(54) Method for accessing vehicle status data and performing feature customization

(76) Inventors: Scott A. McCullough, Sterling Heights, MI (US); Lisa D. Weber, Macomb, MI (US); Katrina M. Schultz, Clarkston, MI (US); Charles G. Ferrara, Royal Oak, MI (US); Andrew W. Gellatly, Macomb, MI (US); Brian J. Ciesinski, Rochester Hills, MI (US); William R. Price, Grand Blanc, MI (US); John S. Canu, Rochester Hills, MI (US); John E. Paluch, Macomb Township, MI (US); Craig Atiyeh, Grand Blanc, MI (US); Thomas A. Wilson, Rochester Hills, MI (US); Charles A. Green, Canton, MI (US); Jacqueline A. Chestnut, Sterling Heights, MI (US); Patricia J. Featherstone, Grosse Pointe Shores, MI (US); Yuan Yuan Liu, Jersey City, NJ (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/220,118

(22) Filed: Sep. 6, 2005

(51) Int. Cl. G06F 17/00

(52) U.S. Cl. 701/1; 701/36

(57) ABSTRACT

A method for customizing a selected one of a plurality of customizable vehicle features on a vehicle equipped with an onboard processor and a user interface including a display and a first plurality of user input controls. The method comprises displaying on the display a vehicle feature menu and scrolling therethrough with a first one of the plurality of user input controls. A vehicle feature mode menu is displayed on the display and is scrolled through with a first of the plurality of user input controls. The second one of the plurality of user input controls is utilized to navigate from the vehicle feature menu to the vehicle feature mode menu.

### TECHNICAL FIELD

The present invention relates generally to vehicle control systems, and more particularly to a method for accessing vehicle status data and performing feature customization.

### BACKGROUND OF THE INVENTION

Vehicles are becoming increasingly equipped with various features that can be manipulated or adjusted by a driver or passenger of the vehicle. A user may be permitted to select amongst a variety of operative settings or modes associated with a particular feature. In this manner, a user may adjust vehicle features to personal preference and thus customize or personalization the vehicle. Headlights, door locks, interior lighting settings, and key fob door lock and unlock feedback are only a few examples of such vehicle features that may now be customized by a user. As the number of customizable vehicle features and the modes associated therewith grow, it becomes increasingly desirable to implement a customization process that is practical, efficient, and user-friendly.

One known data acquisition and feature customization process utilizes a vehicle's odometer display and trip stem. In this system, the odometer display is used to display a series of numbers that represent vehicle features (option codes) and different modes thereof (option modes). A user may navigate through a hierarchy of these option codes and modes by manipulating the odometer trip stem. For example, a user may first press and hold the trip stem until a group of numbers representing a particular function begins to flash. The user may then sequentially scroll through the numbers until a code representing the feature to be adjusted is found and then select that feature by pressing and holding the trip stem. Next, the user may sequentially scroll through codes representing various modes associated with the selected vehicular feature by tapping the trim stem and select amongst them by pressing and holding the trip stem. After the user selects an option mode, the control system signals an onboard processor, which then configures the corresponding vehicle feature in accordance with the desired adjustment.

Though platforms utilizing a vehicle's odometer interface do enable vehicle feature customization, display and control limitations may render the customization process relatively confusing and cumbersome. Fortunately, more advanced interfaces have been developed and are becoming increasingly prevalent on motor vehicles. One such control system, referred to as a Driver Information Center (DIC), provides a display (e.g., LCD) capable of displaying several lines of characters and includes a plurality of user inputs (e.g., buttons) disposed thereon. As these interfaces are relatively new, user-friendly customization processes that take full advantage of the DIC interface have not been implemented. It should thus be appreciated that it would be desirable to provide a user-friendly feature customization process for use in conjunction with a mutli-line display/multi-input interface, such as that employed in a DIC control system.

As it is increasingly important to implement a user-friendly customization process, so too is it increasingly important to implement a management system for organizing the ever-growing number of statistical items describing the status of various vehicular features (e.g., gas mileage, tire pressure, oil life, etc). A well-organized process for accessing such vehicle status data permits a user to more easily find and view desired information about his or her vehicle. It should thus also be appreciated that it would be desirable to provide a vehicle feature management process that provides a relatively straightforward process for accessing and viewing vehicle status data.

### BRIEF SUMMARY OF THE INVENTION

According to a broad aspect of the invention there is provided a method for customizing a selected one of a plurality of customizable vehicle features on a vehicle equipped with an onboard processor and a user interface including a display and a first plurality of user input controls. The method comprises displaying on the display a vehicle feature menu and scrolling therethrough with a first one of the plurality of user input controls. A vehicle feature mode menu is displayed on the display and is scrolled through with a first of the plurality of user input controls. The second one of the plurality of user input controls is utilized to navigate from the vehicle feature menu to the vehicle feature mode menu.

According to a further aspect of the invention there is provided an apparatus for customizing a selected one of a plurality of customizable features on a vehicle comprising a processor onboard the vehicle, a plurality of user input controls coupled to the processor, and a display coupled to the processor. The display displays a vehicle feature menu and a vehicle feature mode menu. A first one of the plurality of user input controls is used to scroll through the vehicle feature menu and the vehicle feature mode menu and a second one of the plurality of user input controls is used to navigate therebetween.

According to a still further aspect of the invention there is provided a method for customizing a plurality of adjustable features on a vehicle having an onboard processor and a user interface comprising a display and at least first and second user input controls. The method comprises displaying a first menu on the display comprising a first plurality of adjustable feature options and inputting user feature selection data via the at least first and second user input controls. The user feature selection data is used to select one of the first plurality of adjustable feature options. A second menu comprising a second plurality of feature mode options corresponding to the selected one of the first plurality of adjustable feature options is displayed on the display. User feature mode selection data is inputted via the at least first and second user input controls and used to select one of the second plurality of feature mode options. The processor processes the user feature mode selection data and the selected adjustable feature is adjusted in accordance with the user feature mode selection data.

### BRIEF DESCRIPTION OF THE DRAWINGS

The present invention will hereinafter be described in conjunction with the following figures, wherein like numerals denote like elements, and:

FIG. 1 is a block diagram of a Driver Information Center (DIC) control system;

FIG. 2 is a flow chart illustrating a first embodiment of the inventive vehicular data management and feature customization process for use in conjunction with a DIC control system of the type depicted in FIG. 1 having a four-button user interface; and

FIG. 3 is a flow chart illustrating a second embodiment of the inventive vehicular data management and feature customization process for use in conjunction with a DIC control system of the type depicted in FIG. 1 having a six-button user interface.

### DETAILED DESCRIPTION OF THE INVENTION

The following detailed description of the invention is merely exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

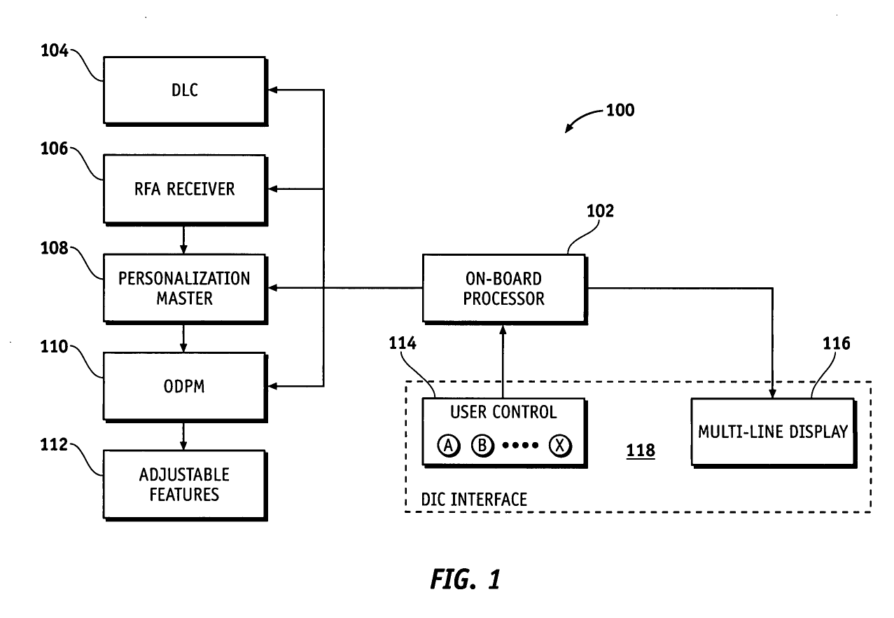

FIG. 1 is a block diagram of a Drive Information Center (DIC) control system 100. DIC control system 100 includes a DIC user interface 118 that comprises a display 116 capable of displaying several lines of alphanumeric characters and a user control 114 having a plurality of inputs A through X (e.g., buttons) disposed thereon. Inputs A through X provided on user control 114 receive user selection data provided by a user. That is, by way of user control 114, a user may specify a particular feature to be selected (user feature selection data), a particular mode in which a selected feature is to be placed (user feature mode selection data), a particular menu display to be accessed (user feature menu navigation data), and a particular informational item to be viewed (vehicle status selection data). User interface 118 is coupled via a serial data link to on-board processor 102, which is similarly coupled to a Data Link Connector (DLC) 104, a Remote Function Actuator (RFA) receiver 106, a personalization master 108, and an Occupant Position Device Master (OPDM) 110. Control system 100 permits a driver to adjust an adjustable feature 112 (e.g., the seats, steering wheel, pedals, mirrors, etc.) of a motor vehicle. Additionally, control system 100 may permit the programming of conditions under which certain vehicular tasks or functions are to be performed. For example, control system 100 may be utilized to program the vehicle doors to lock at a particular vehicle speed.

A vehicle may remain configured to the most recent user adjustments, or control system 100 may be switched between different groups of adjustments associated with different drivers in the well-known manner. Control system 100 may automatically configure adjustable vehicular features in accordance with a driver-specific setting group in the following way. First, personalization master 108 determines driver identity by, for example, wireless reception (via RFA receiver 106) of a signal emitted by a driver-specific keyfob. Personalization master 108 then transmits a corresponding driver identification signal to OPDM 110, which stores multiple groups of settings associated with different drivers. OPDM 110 recalls the settings associated with the identified driver and customizes feature 112 accordingly. To establish a driver-specific setting group, or simply to adjust a vehicular feature, control system 100 may employ the inventive feature customization process described more fully hereinbelow.

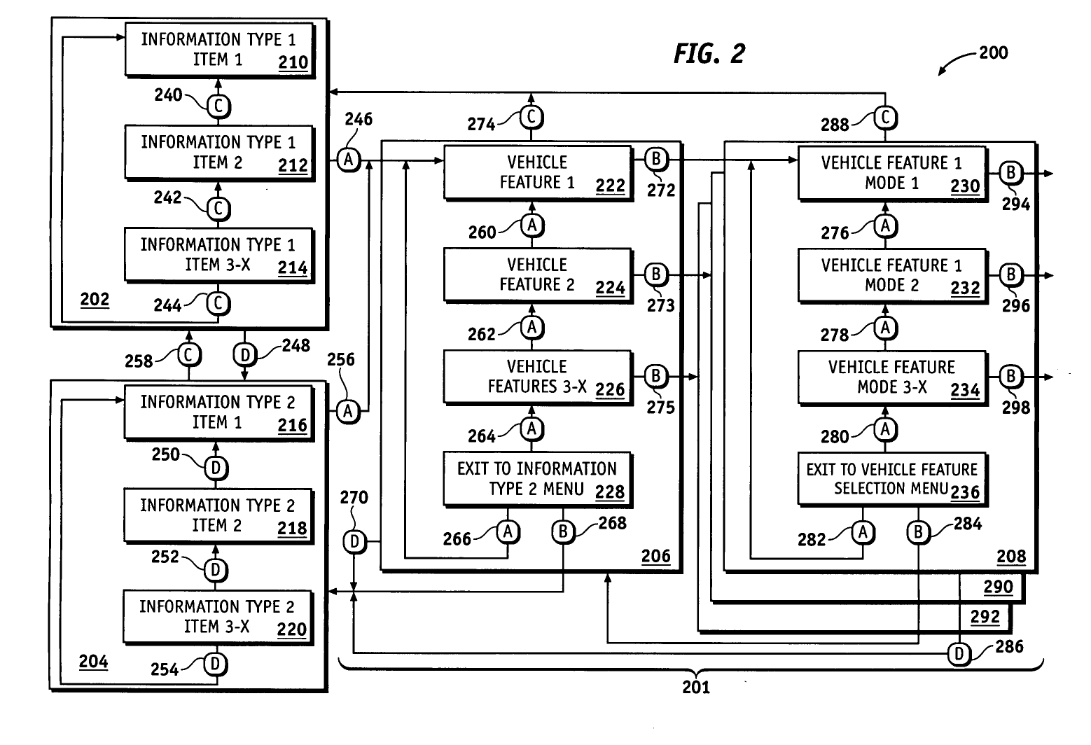

FIG. 2 is a flow chart illustrating a first embodiment of the inventive vehicle feature management process for use in conjunction with a DIC control system of the type depicted in FIG. 1. In this embodiment, user control 114 of DIC interface 118 (FIG. 1) comprises four buttons, hereafter referred to as buttons A, B, C, and D. During the feature management process, a user utilizes buttons A, B, C, and D to navigate through an arrangement or structure of menus 200, select features and feature modes, and access vehicle status data (e.g., gas mileage). Menu structure 200 comprises three main menu groups: a first menu group 202 showing display readings associated with a first type of information (i.e., display readings 210, 212, and 214 associated with Information Type 1), a second menu group 204 showing display readings associated with a second type of information (i.e., display readings 216, 218, and 220 associated with Information Type 2), and a third menu group 201 illustrating a two-level menu hierarchy comprising first level vehicle feature menu 206 and second level feature mode menu 208.

The first level of menu group 201 consists of first level feature menu 206 comprising a plurality of adjustable vehicle features (i.e., Vehicle Features 1, 2, and 3—X shown at display readings 222, 224, and 226, respectively) and an EXIT option (shown at display reading 228). The second level of menu group 201 consists of a plurality of menus, each of which comprises modes into which one of vehicle features 1 through X may be placed. That is, each second level feature mode menu corresponds to an adjustable vehicle feature listed in first level menu 206. In embodiment shown in FIG. 2, second level feature mode menu 208 corresponds to Vehicle Feature 1 shown at display reading 222, second level feature mode menu 290 corresponds to Vehicle Feature 2 shown at display reading 224, and second level feature mode menus 292 correspond to Vehicle Features 3 through X shown at display reading 226. The display readings comprising second level feature mode menus 290 and 292 are not shown in FIG. 2 for clarity.

It should be appreciated that, although only three menu groups are shown in FIG. 2 (i.e., menu groups 202, 204, and 201), the number of menu groups employed may be varied. Additionally, although only one menu group (i.e., menu group 201) is shown as having a tiered hierarchy, it should be appreciated that other menu groups may comprise a hierarchy. Lastly, although menu group 201 is shown in FIG. 2 as comprising only a two-level hierarchy, it should be understood that a menu group may comprise a tiered hierarchy of any desirable number of levels.

Buttons A, B, C, and D of DIC user control 114 (FIG. 1) are programmed in the following way. Button A performs two functions. First, when display 116 (FIG. 1) is displaying a reading associated with menu group 202 or 204, pressing button A will cause display 116 (FIG. 1) to migrate to the last reading displayed in first level menu 206 (e.g., reading 222). Second, when display 116 (FIG. 1) is displaying a reading associated with menu group 201, button A may be used to scroll through display readings (e.g., for first level feature menu 206, to scroll through readings 222, 224, 226, 228, and back to 222; or, for second level feature mode menu 208, to scroll through readings 230, 232, 234, 236, and back to 230).

Button B is programmed to select amongst menu options within menu group 201. Button B may be pressed to choose a vehicle feature when in a vehicle feature menu (i.e., first level vehicle feature menu 206), or to choose a vehicle feature mode when in a vehicle feature mode menu (i.e., second level vehicle feature mode menus 208, 290, or 292). That is, when an adjustable vehicle feature of first level feature menu 206 (e.g., Vehicle Feature 1, Vehicle Feature 2, and Vehicle Features 3—X) is shown on display 116 (FIG. 1), button B may be pressed to enter the second level feature mode menu (e.g., second level feature mode menus 208, 290, and 292, respectively) comprising various modes in which the selected feature may be placed. When a feature mode of a second level feature mode menu (e.g., menu 208, 290, or 290) is shown on display 116 (FIG. 1), button B may be pressed to select the desired feature mode. After feature mode selection, display reading 116 (FIG. 1) will return to the last reading displayed in the previous menu (e.g., in FIG. 2, display reading 222_of first level menu 206) and processor 102 (FIG. 1) will signal corresponding vehicle feature 112 to perform the desired adjustment

As stated above, the feature modes that comprise second level feature mode menus 290 and 292 are not shown in FIG. 2 for clarity. Instead, FIG. 2 shows only the modes that comprise second level feature mode menu 208 (i.e., modes 1, 2, and 3—X shown at 230, 232, and 234, respectively). These modes represent potential settings in which Vehicle Feature 1 (shown at 222) may be placed. To reach this feature mode menu, Vehicle Feature 1 (shown at 222) may be selected from first level feature menu 206 by pressing button B as is shown at 272. After feature mode menu 208 has been accessed, button A may be used to scroll through the listed feature modes (i.e., feature modes 1—X). After the desired mode is located, button B may again be pressed to select the desired feature mode (as shown at 294 for Feature 1, 296 for Feature 2, and 298 for Feature 3). Control system 100 (FIG. 1) then responds in the above described manner to perform the desired adjustment.

Button C is programmed similarly to button A and performs two functions. When display 116 (FIG. 1) is displaying a reading associated with menu group 204 or 201, pressing button C will cause display 116 (FIG. 1) to migrate to the last reading displayed in menu group 202 (e.g., reading 210). When display 116 (FIG. 1) is displaying a reading associated with menu group 202, button C may be used to scroll through display readings (e.g., to scroll through reading 210, 212, 214, and back to 210).

Button D is programmed similarly to buttons A and C and performs two functions. When display 116 (FIG. 1) is displaying a reading associated with menu group 202 or 201, pressing button D will cause display 116 (FIG. 1) to migrate to the last reading displayed in_menu group 204 (e.g., reading 216). When display 116 (FIG. 1) is displaying a reading associated with menu group 204, button D may be used to scroll through display readings (e.g., to scroll through reading 216, 218, 220, and back to 216).

As described above, buttons A, B, C, and D may be used to navigate through menu structure 200. To view a particular item of information, a user utilizes button C or D to access the appropriate information type group (e.g., Information Type 1 group 202, or Information Type 2 group 216) and scroll through the listed informational items (e.g., for Information Type 1 group 202, Item 1 at reading 210, Item 2 at reading 212, and Items 3—X at reading 214; for Information Type 2 group 204, Item 1 at reading 216, Item 2 at reading 218, and Items 3—X at reading 220). Information of various types may be displayed in menu grouping 202 or 204. Information Type 1 of menu group 202 may, for example, consist of information generally regarding vehicle care (e.g., oil life), and may be referred to as VEHICLE CARE menu group 202. VEHICLE CARE menu group 202 may comprise a number (X) of informational items of any suitable type. For example, VEHICLE CARE menu group 202 may comprise an item describing remaining oil life at display reading 210, the number of miles until scheduled service at display reading 212, and tire pressure and the average temperature of the engine at display reading 214, etc.

Using the exemplary feature and mode assignments just described, a user might view the number of miles until scheduled service (Item 2 of Information Type 1 displayed at reading 212 in menu group 202) in the following way. To begin, the user accesses VEHICLE CARE menu group 202 by pressing button C from any display reading other than one associated with menu group 202. This is shown at 258 if display reading 116 (FIG. 1) is currently displaying a reading associated with menu group 204, at 274 if the current display reading is associated with menu group 206, or at 288 if the current display reading is associated with menu group 208. After VEHICLE CARE menu group 202 has been accessed, display 116 (FIG. 1) may migrate to the last reading displayed in menu group 202. For example, display 116 may display reading 210, which is, in accordance with the present example, an informational item describing oil life. Button C is then pressed (shown at 240) to progress from display reading 210 to display reading 212 (i.e., the number of miles until scheduled service). To view additional information associated with VEHICLE CARE, a user may continue to press button C and thereby scroll through the remaining display readings (i.e., display reading 214). When the last item and display reading is reached (e.g. Item X of display reading 214), pressing button C will return display 116 (FIG. 1) to the first item and display reading in menu 202 (i.e., Item 1 and reading 210).

As stated above, a variety of types of information may be displayed in a menu grouping. Information Type 2 of menu group 204 may, for example, comprise information generally regarding vehicle travel (e.g., statistics relating to fuel use and distances traveled), and may be referred to as the TRIP/FUEL menu group. TRIP/FUEL menu group 204 may comprise a number (X) of informational items of any suitable type. For example, TRIP/FUEL menu group 204 may comprise an item describing gas mileage at display reading 216, the average number of miles traveled per spent gas tank at display reading 218, and the number of remaining miles able to be traveled before the gas supply is exhausted, the number of miles the vehicle has traveled during the current excursion, and the direction the vehicle is traveling at display reading 220, etc.

Viewing an item within TRIP/FUEL menu group 204 may be accomplished in much the same way an as viewing an item within menu group 202. That is, menu structure 200 is designed such that the last displayed reading of Information Type 2 menu group 204 can be accessed by pressing D from any display reading associated with menu groups 202 or 201 (as represented at 248 for menu group 202, 270 for menu group 206, and 286 for menu group 208). However, unlike menu group 202, menu group 204 may be accessed by selecting an EXIT option provided as the last option (reading 228) of first level menu group 206 with button B, as will be more fully discussed hereinbelow. Pressing button D while viewing a reading associated with menu group 204 scrolls through the display readings in the above described manner.

In FIG. 2, vehicle feature customization is primarily accomplished by navigating through and selecting amongst readings within menu group 201 with buttons A and B. To begin the customization process, first level feature menu 206 may be accessed by pressing button A from any display reading not associated with menu group 201 (i.e., menu group 202 or 204 as shown at 246 and 256, respectively), or by selecting the EXIT option with button B provided as the last option of all second level feature mode menus (e.g., reading 236 of second level feature mode menu 208 as shown at 284). After first level menu 206 has been accessed, display 116 (FIG. 1) may migrate from its former reading to the last reading displayed in first level menu 206. For illustrative purposes, the following assumes that the last reading displayed in first level menu 206 was display reading 222.

From the first display reading of first level feature menu 206 (i.e., display reading 222), one of two paths may be taken: (1) the second level menu group associated with the currently displayed vehicle feature (i.e., second level menu group 208 associated with Vehicle Feature 1 displayed at 222) may be accessed by pressing button B as is shown at 272, or (2) the next display reading and vehicle feature (i.e., display reading 224 and Vehicle Feature 2) may be reached by pressing button A as shown at 260. If button A is pressed, display 116 (FIG. 1) migrates from reading 222 to 224 and the user will once again be confronted with the two possible paths: (1) the second level menu group associated with the currently displayed vehicle feature (i.e., a second level menu group 290 associated with Vehicle Feature 2 displayed at 224) may be accessed by pressing button B as shown at 273, or (2) the next display reading and vehicle feature (i.e., display reading 226 and Vehicle Feature 3) may be reached by pressing button A as shown at 262. This process of navigating through first level menu 206 is repeated until (1) a second level feature mode menu is accessed, or (2) all display readings (i.e., display readings 222, 224, and 226) have been scrolled through, in which case display 116 (FIG. 1) may display an EXIT option (i.e., reading 228). A user may select this EXIT option (i.e., reading 228) by pressing button B as is shown at 268 and thereby cause display 116 (FIG. 1) to migrate to the last reading displayed in_a different menu group (e.g., menu group 204). Alternatively, button A may be pressed as shown at 266 to return display 116 (FIG. 1) to the first display reading in menu group 206 (i.e., display reading 222).

After a vehicle feature has been selected in the above-described manner, display 116 (FIG. 1) migrates from first level feature menu 206 to a second level feature mode menu. As stated above, only the display readings comprising second level menu 208 are shown in FIG. 2 for simplicity. Second level feature mode menu 208 is associated with Vehicle Feature 1 identified in display reading 222, and comprises modes into which Vehicle Feature 1 may be placed. A user may select amongst these modes by: (1) locating the desired mode by scrolling through display readings (i.e., readings 230, 232, and 234) with button A (as shown at 276, 278, and 280, respectively), and (2) by selecting the desired mode with button B (as shown at 294, 296, and 298, respectively). After a mode is selected, display 116 (FIG. 1) may return to, for example, the last reading displayed in the previous menu (e.g., reading 222 of first level menu 206). If a user scrolls through all feature modes, display 116 (FIG. 1) may display an EXIT option (i.e., display reading 236). A user may select this EXIT option (i.e., display reading 236) by pressing button B as is shown at 284 and thereby cause display 116 (FIG. 1) to migrate to, for example, the last reading displayed in the previous menu (e.g., reading 222 of first level feature menu 206), or button A may be pressed as shown at 282 to return display 116 (FIG. 1) to the first display reading (i.e., display reading 230) in the menu currently viewed (i.e., second level feature mode menu 208). If desired, an indication means (e.g., a signal, such as a check mark or a textbox) may be provided on each second level feature mode menu proximate the feature mode option representative of the current feature mode setting. In this way, a user may be provided with a visual indication of the mode in which a given feature is currently operating.

First level feature menu 206 may comprise a variety of adjustable vehicle features. For example, Vehicle Feature 1 (display reading 222) may be KEYFOB DOOR LOCK RESPONSE OPTIONS, Vehicle Feature 2 (display reading 224) may be DISPLAY LANGUAGE OPTIONS, Vehicle Feature 3 (display reading 226) may be AUTOMATIC DOOR LOCK OPTIONS, Vehicle Feature 4 (display reading 226) may be RIDE FEEL OPTIONS, Vehicle Feature 5 (display reading 226) may be AUTOMATIC HEADLIGHT OPTIONS, etc. As explained above, each adjustable vehicle feature has a plurality of modes associated therewith displayed in a second level feature mode menu of menu group 201, which may be accessed by pressing button B when the feature is displayed on display 116 (FIG. 1). For example, Vehicle Feature 1 may be KEYFOB DOOR LOCK RESPONSE OPTIONS and have a second level feature mode menu (i.e., second level feature mode menu 208) associated therewith comprising various modes in which the KEYFOB DOOR LOCK RESPONSE may be placed. These modes might include HORN CHIRP as Mode 1 at 230, FLASH LIGHTS as Mode 2 at 232, HORN CHIRP AND FLASH LIGHTS as Mode 3 at 234, and NO RESPONSE as Mode 4 at 234.

To further illustrate a Vehicle feature and mode assignment, the following relates to the way in which a user might customize the KEYFOB DOOR LOCK RESPONSE feature (i.e., the user feedback provided when a vehicle receives a wireless door lock signal) to select a HORN CHIRP AND FLASH LIGHTS mode (i.e., the vehicle briefly sounds the horn and flashes the lights). To begin, first level menu 206 is accessed in the above-described manner. This may cause display 116 (FIG. 1) to display the last reading displayed in first level menu 206. For example, display 116 may display the first reading (i.e., reading 222) of first level menu 206, which happens to be the feature the user wishes to adjust (i.e., feature 1, which is, in this example, KEYFOB DOOR LOCK RESPONSE OPTIONS). The user selects this feature by pressing button B as is shown 272. This causes display 116 (FIG. 1) to migrate from display reading 222 of first level feature menu 206 to display reading 230 of second level feature mode menu 208. The first feature mode displayed for KEYFOB DOOR LOCK RESPONSE is HORN CHIRP, which is shown as Mode 1 at display reading 230 in FIG. 2. Button A is then pressed twice to progress from display reading 230 to display reading 232 and display reading 232 to display reading 234 as is shown at 276 and 278, respectively. At display reading 234, display 116 (FIG. 1) displays Mode 3, HORN CHIRP AND FLASH LIGHTS. As this is the mode the user desires, button B is pressed and the HORN CHIRP AND FLASH LIGHTS mode is selected. Display 116 (FIG. 1) then returns to the display reading last displayed in the previous menu (e.g., reading 222 of first level menu 206), and processor 102 (FIG. 1) signals the corresponding Vehicle Feature 112 (i.e., KEYFOB DOOR LOCK RESPONSE) to accomplish the desired adjustment.

As stated above, second level feature mode menus 290 and 292 associated with Vehicle Features 2 and 3 through X, respectively, have not been shown in FIG. 2 for clarity. However, the following modes may be made available for the exemplary features just set forth: modes for Vehicle Feature DISPLAY LANGUAGE may include ENGLISH, FRENCH, and SPANISH; modes for Vehicle Feature AUTOMATIC DOOR LOCK may include LOCK WHEN IN GEAR, LOCK WHEN 5 MPH, DO NOT AUTOMATICALLY LOCK; modes for Vehicle Feature RIDE FEEL may include NORMAL, COMFORT, SPORT, PERFORMANCE, and TOURING; and modes for Vehicle Feature AUTOMATIC HEADLIGHTS may include AUTOMATICALLY TURN ON WHEN DARK and DO NOT AUTOMATICALLY TURN ON. Other adjustable vehicle features might include: KEYFOB DOOR UNLOCK RESPONSE, EASY KEY LOCKING/UNLOCKING RESPONSE, AUTOMATIC DOOR UNLOCK, VEHICLE EXIT LIGHT TIMING, SMART HIGH BEAM LIGHT, CHIME VOLUME, HORN CHIRP VOLUME, PARKING TILT MIRRORS, DRIVER SEAT ENTRY, ENTRY/EXIT VEHICLE LOWERING/KNEELING, MEMORY SEAT REMOTE RECALL, REMOTE START, VEHICLE LOAD AUTO ADJUST, VEHICLE SHIFT FEEL, ANTI-THEFT SYSTEM, RAIN-SENSING WIPERS, etc.

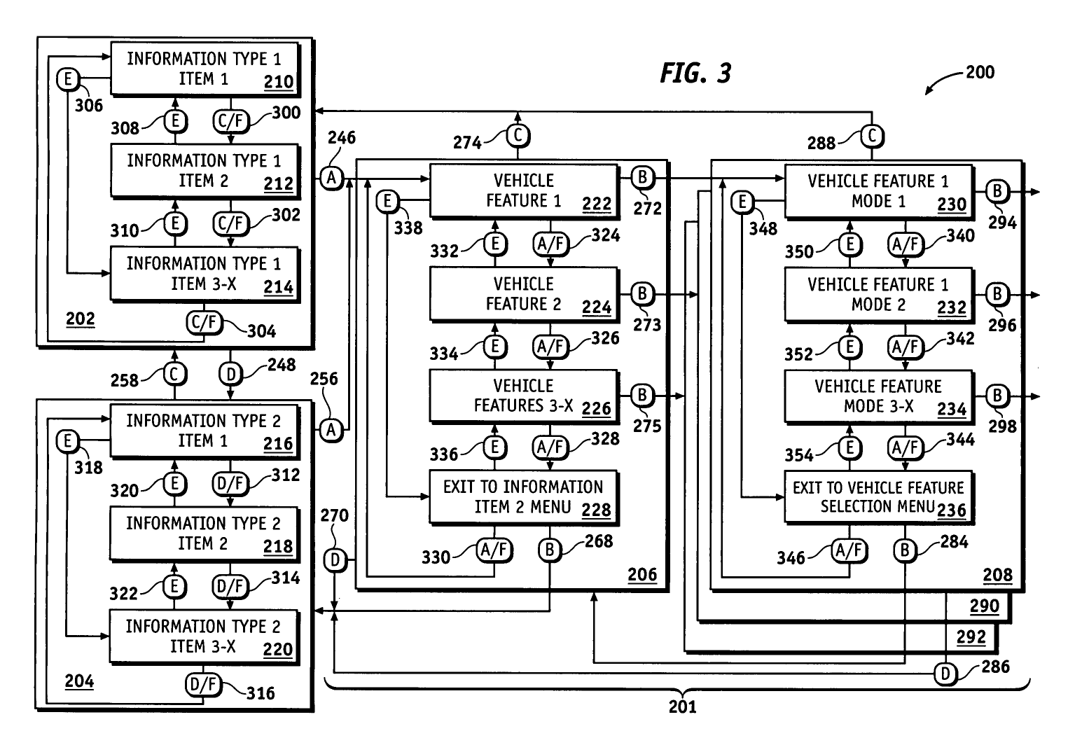

FIG. 3 is a flow chart illustrating a second embodiment of the inventive vehicle feature management process for use in conjunction with a DIC control system of the type depicted in FIG. 1 having a six-button user control 114 (FIG. 1). In this embodiment, user control 114 of DIC interface 118 (FIG. 1) comprises six buttons, hereafter referred to as buttons A, B, C, D, E, and F. During the feature management process, a user utilizes buttons A, B, C, D, E, and F to navigate through and select amongst readings provided within menu structure 200 described hereinabove.

Buttons A, B, C, and D of user control 114 (FIG. 1) are programmed as described above in conjunction with FIG. 2. In accordance with the embodiment as shown in FIG. 3, additional buttons E and F of user control 114 (FIG. 1) are provided for scrolling up and down, respectively, through the menu display readings. For example, display 116 (FIG. 1) will migrate from display reading 224 to display reading 222 when button E is pressed as is shown at 332. Conversely, display 116 (FIG. 1) will migrate from display reading 222 to display reading 224 when button F is pressed as is shown at 324. In this way, the embodiment shown in FIG. 3 may make navigation through menu structure 200 easier and quicker.

It should be appreciated that, if desired, the inventive vehicle feature management process may include a time-out function wherein display 116 (FIG. 1) automatically migrates to a particular reading when no user input is received during a predetermined amount of time. For example, display 116 (FIG. 1) may automatically return to the last reading displayed in a menu group (e.g., menu group 204 described above as the FUEL/TRIP menu group) after no user input has been received during period of fifteen seconds.

It should further be appreciated that menus employed in the inventive feature management process may be shown on display 116 (FIG. 1) in a variety of ways. For example, the menu options comprising a given menu may be displayed one at a time. In this case, scrolling through menu options may result in display 116 (FIG. 1) migrating in its entirety from the former menu option to the current menu option in accordance with user input. Alternatively, menu options comprising a given menu may be showed jointly. In this case, scrolling through menu options may simply move an indication means (e.g., a symbol such as a check or a text box) from the former menu option to the current menu option in accordance with user input.

Thus, there has been provided a vehicle data and feature management process comprising a user-friendly data retrieval and feature customization process for use in conjunction with a mutli-line display/multi-input interface, such as employed by a Driver Information Center (DIC) control system utilizing a plurality of user control inputs.

While multiple embodiments have been presented in the foregoing detailed description, it should be appreciated that a vast number of variations exist. It should also be appreciated that the exemplary embodiments are only examples, and are not intended to limit the scope, applicability, or configuration of the invention in any way. For example, while the embodiment shown in FIGS. 2 and 3 utilize four and six buttons, respectively, a different number of controls may be utilized. Rather, the foregoing detailed description will provide those skilled in the art with a convenient road map for implementing the exemplary embodiments. It should be understood that various changes can be made in the function and arrangement of elements without departing from the scope of the invention as set forth in the appended claims and the legal equivalents thereof.

1. A method for customizing a selected one of a plurality of customizable features on a vehicle equipped with an onboard processor and a user interface including a display and a first plurality of user input controls, said method comprising:
displaying a vehicle feature menu on said display;
scrolling through said vehicle feature menu utilizing a first one of said plurality of user input controls;
displaying a vehicle feature mode menu on said display;
scrolling through said vehicle feature mode menu utilizing said first one of said first plurality of user input controls; and
navigating from said vehicle feature menu to said vehicle feature mode menu utilizing a second one of said plurality of user input controls.

2. The method for customizing according to claim 1 wherein said step of navigating further comprises:
selecting a desired feature from said vehicle feature menu with said second one of said plurality of user input controls; and
selecting a desired mode from said vehicle feature mode menu with said second one of said plurality of user input controls.

3. The method for customizing according to claim 2 wherein said step of selecting a mode option is followed by displaying said vehicle feature mode menu.

4. The method for customization according to claim 2 further comprising:
displaying a first information item menu comprising vehicle status data of a first type; and
scrolling through said first informational item menu utilizing a third one of said plurality of user input controls.

5. The method for customization according to claim 4 wherein said step of displaying said first informational item menu is initiated by utilizing said third of said plurality of user inputs controls.

6. The method for customization according to claim 5 further comprising:
displaying a second informational item menu comprising vehicle status data of a second type; and
scrolling through said second informational item menu utilizing a fourth one of said plurality of user input controls.

7. The method for customization according to claim 6 wherein said step of displaying said second informational item menu is initiated by utilizing said fourth of said plurality of user input controls.

8. The method for customization according to claim 7 wherein said steps of scrolling through said vehicle feature menu, scrolling through said vehicle feature mode menu, scrolling through said first informational item menu, and scrolling through said second informational item menu is accomplished utilizing fifth one and sixth ones of said plurality of user input controls.

9. The method for customization according to claim 8 wherein said fifth and said sixth ones of said plurality of user input controls scroll downward and upward, respectively.

10. An apparatus for customizing a selected one of a plurality of customizable features on a vehicle, said apparatus comprising:
a processor onboard said vehicle;
a plurality of user input controls coupled to said processor; and
a display coupled to said processor for displaying a vehicle feature menu and a vehicle feature mode menu, a first one of said plurality of user input controls for scrolling through said vehicle feature menu and said vehicle feature mode menu, a second one of said plurality of user input controls for navigating between said vehicle feature menu and said vehicle feature mode menu.

11. An apparatus for customizing according to claim 10 wherein said display displays a first informational menu including vehicle status data of a first type and a third one of said plurality of user input controls is utilized for accessing and scrolling through said first informational menu.

12. An apparatus for customizing according to claim 11 said display displays a second informational menu including vehicle status data of a second type and a fourth one of said plurality of user input controls is utilized for accessing and scrolling through said second informational menu.

13. An apparatus for customizing according to claim 12 wherein a fifth one of said user input controls is utilized for scrolling downward through said vehicle feature menu, said vehicle feature mode menu, said first informational menu, and said second informational menu.

14. An apparatus for customizing according to claim 13 wherein a sixth one of said user input controls is utilized for scrolling upward through said vehicle feature menu, said vehicle feature mode menu, said first informational menu, and said second informational menu.

15. An apparatus for customizing according to claim 14 wherein said plurality of user input controls are deployed as part of a driver information center.

16. A method for customizing a plurality of adjustable features on a vehicle having an onboard processor and a user interface comprising a display and at least first and second user input controls, said method comprising:
displaying a first menu on said display comprising a first plurality of adjustable feature options;
inputting user feature selection data via said at least first and second user input controls, said user feature selection data for selecting one of said first plurality of adjustable feature options;
displaying a second menu on said display comprising a second plurality of feature mode options corresponding to the selected one of said first plurality of adjustable feature options;
inputting user feature mode selection data via said at least first and second user input controls, said user feature mode selection data for selecting one of said second plurality of feature mode options;
processing the user feature mode selection data in said processor; and
adjusting the selected adjustable feature in accordance with the user feature mode selection data.

17. The method for customizing according to claim 16 wherein said step of inputting user feature selection data further comprises:
scrolling through said first plurality of adjustable feature options and locating a desired one thereof with a first of said at least first and second user input controls; and
selecting said desired adjustable feature option with a second of said at least first and second user input controls.

18. The method for customizing according to claim 17 wherein said step of inputting user feature mode selection data further comprises:
scrolling through said second plurality of adjustable feature mode options and locating a desired one thereof with said first of said at least first and second user inputs; and
selecting said desired adjustable feature mode option with said second of said at least first and second user input controls.

19. The method for customizing according to claim 18 further comprising:
displaying a third menu on said display comprising a third plurality of informational items, said informational items indicative of vehicle status data; and
scrolling through said third plurality of informational items and locating a desired one thereof.

20. The method for customizing according to claim 19 wherein said step of scrolling through said third plurality of informational items is accomplished utilizing a third one of said at least first and second user input controls.

21. The method for customizing according to claim 20 wherein said step of displaying a third menu is initiated by utilizing said third one of said at least first and second user input controls.

22. The method for customizing according to claim 21 further comprising:
displaying a fourth menu on said display comprising a fourth plurality of informational items, said informational items indicative of vehicle status data; and
scrolling through a fourth plurality of informational items and locating a desired one thereof.

23. The method for customizing according to claim 22 wherein said step of scrolling through said fourth plurality of informational items is accomplished utilizing a fourth one of said at least first and second user input controls.

24. The method for customizing according to claim 23 wherein said step of displaying a fourth menu is initiated by utilizing said fourth one of said at least first and second user input controls.

25. The method for customizing according to claim 24 wherein said step of scrolling through said first plurality of adjustable feature options, scrolling through said second plurality of feature mode options, scrolling through said third plurality of informational items, and scrolling through said fourth plurality of informational items is accomplished utilizing fifth and sixth ones of said at least first and second user input controls.

26. The method for customizing according to claim 25 wherein the step of scrolling comprises:
scrolling downward using said fifth one of said at least first and second user input controls; and
scrolling upward using said sixth one of said at least first and second user input controls.
